(19) United States
(12) Patent Application Publication
(10) Pub. No.: US 2002/0198731 A1
(43) Pub. Date: Dec. 26, 2002

(54) Method and apparatus for processing an international passenger

(76) Inventors: Jessica M. Barnes, Schaumburg, IL (US); Michael A. Thomas, Kenilworth, IL (US)

Correspondence Address: BRINKS HOFER GILSON & LIONE, P.O. BOX 10395, CHICAGO, IL, 60610, US

(21) Appl. No.: 09/893,240

(22) Filed: Jun. 26, 2001

(51) Int. Cl. G06F 17/60

(52) U.S. Cl. 705/1

(57) ABSTRACT

An apparatus and method for expediting customs and immigration processing is revealed. Passports are scanned and checked against an image of passengers at check in and boarding. This information is forwarded to a government representative, such as an Immigration service representative, and may also be sent to a Customs official. These or other governmental representatives may then decide whether the government has any interest in a particular passenger, and the passenger may be routed in compliance with the governmental interest. A customs declaration for each passenger and an inspection record (such as an x-ray) of passenger luggage may be made and forwarded to a customs official. The customs official may then decide which persons and which baggage to check, routing such baggage and such persons to a customs inspection area. Passengers and luggage not selected may be automatically cleared without further inspection.

### BACKGROUND OF THE INVENTION

This invention pertains to the field of air travel transportation and in particular the field of processing passengers through customs and immigration services of a destination country. It also concerns the automatic acquisition and processing of data concerning the passengers.

Air travel of passengers between countries has expanded significantly over the past 30 years. An ever-increasing number of passengers are taking advantage of the convenience and speed of air travel for a variety of reasons.

These reasons include business travel, leading to the growth in international trade and increasing interdependence of the economies of many countries participating in trade. The reasons for the expansion of air travel also include pleasure travel, leading to growth in tourism and hospitality industries around the globe.

Large jet aircraft enplane and deplane hundreds of passengers on every flight from an out-bound nation (point of embarkation) to an in-bound nation (destination). These passengers include businessmen and businesswomen anxious to retrieve their luggage and proceed to their destinations. These passengers include tourists who must clear customs and immigration prior to proceeding. A problem may arise in that it can take a significant amount of time to clear so many passengers through customs inspections considered necessary by almost every sovereign nation. It is in the interest of the destination country to control the flow of both goods and people to their country. A customs and immigration inspection is the normal way to accomplish this control. It is also in the interest of customs and immigration officials to accomplish these inspections quickly. This may give passengers an impression of efficiency and competence on the part of the government of the destination country, allowing the passengers to proceed without unnecessary delay. A pleasant experience may also encourage passengers to return for subsequent trips.

What is needed is a way to quickly clear passengers from an aircraft through customs and immigration, so that the actual time spent in these processes is kept to a minimum. What is also needed is a method and a system to quickly clear passengers and their baggage through customs and immigration.

### BRIEF SUMMARY

The invention is a method and an apparatus to ease the processes of customs and immigration for international passengers. One embodiment is a method for processing an international passenger through customs and immigration requirements of a sovereign nation. A passenger scheduled for an international flight approaches a check-in counter and enters information identifying the passenger into a computer or computer interface linked to a computer network. The information scanned into the computer or computer interface may include a passport photograph or may contain other biometric information uniquely identifying the passenger. In one embodiment, an electronic video or still camera at the check in counter records an image of the passenger. The electronic image is compared with a prior image of the passenger. A boarding pass is issued to passengers whose images match and who are scheduled for the flight. A second video or still camera may be used to record another electronic image of the passenger en route to the aircraft to ensure that the passenger boarding the aircraft is the person who checked in.

Information gathered at the check-in counter is then forwarded to officials in the government of the flight destination country. The officials may compare data from passports and from images recorded at the check-in counter to databases of individuals in which the government has an interest. The government may then instruct the airline as to which passengers should proceed to customs or to immigration, or to both.

Upon arrival at the destination country, the passengers deplane and proceed to an Immigration booth. The passenger enters information identifying the passenger into a computer interface at the Immigration booth, and another video or still camera may be used to record another electronic image of the passenger. The electronic image may be compared to a prior image of the passenger. Other biometric data may be used instead of a photographic image. Once the identity of the passenger is confirmed, the passenger is routed in accordance with instructions from the government. If there is no requirement to be screened at Customs or Immigration, the passenger and the passenger's baggage may be routed automatically for pickup at a domestic baggage carousel or to connecting flights.

Further aspects of the invention will be apparent from the drawings and description of the preferred embodiments detailed below.

### BRIEF DESCRIPTION OF SEVERAL VIEWS OF THE DRAWINGS

FIG. 1 is an overview of the process.

FIG. 2 is a flow chart for a portion of the process in an out-bound country.

FIG. 3 is a flow chart for a portion of the process in an in-bound country.

FIG. 4 is a block diagram of an apparatus for passenger check-in.

FIG. 5 is a block diagram of an immigration counter.

FIGS. 6-8 are flow charts for processes of routing information, passengers, and baggage.

FIG. 9 is an overview of another embodiment of the process.

### DETAILED DESCRIPTION OF THE PRESENTLY PREFERRED EMBODIMENTS

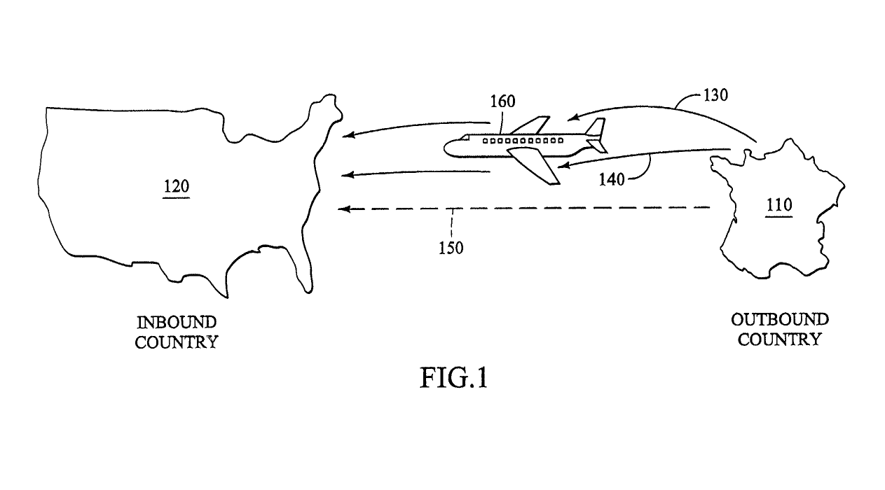

FIG. 1 is an overview of a process for moving an international passenger from an out-bound or originating country 110 to a destination country 120. In one embodiment, these countries may be France and the United States. The process includes transport of the passenger 130, baggage of the passenger 140, and information 150 concerning the passenger and baggage. The passenger and the baggage travel on an aircraft 160. The information may travel through another medium, such as radio or telecommunications between computers.

Facilitating passengers through customs and immigration thus involves breaking the process into at least three separate flows: a flow of information from the passengers and the airline to the customs and immigration officials of the inbound country; a flow of passengers from the out-bound country to the airline flying the passengers and then to an aircraft and to an Immigration point in the in-bound country; and a flow of baggage from the passengers, through at least one inspection station, and then to the in-bound country.

Separating the passengers and baggage in which the government of the destination country shows an interest from all other passengers and baggage may speed up the process. The separation process is made possible by automatically acquiring information concerning the passengers and the baggage and promptly forwarding the information to the government of the destination country. While the aircraft is enroute, the government, typically customs and immigration officials may study the information and decide which passengers and which baggage require personal attention. The officials then communicate this information to the airline. The airline routes the passengers to immigration or customs or to their final destination. The airline also routes the baggage either to customs, to a baggage claim area, or to a further destination for the passenger. Because only about 5% of passengers and baggage are typically of interest to customs or immigration officials, most passengers and their baggage (95%) are processed in an expedited manner, thereby completely bypassing a physical trip to Customs or to Immigration.

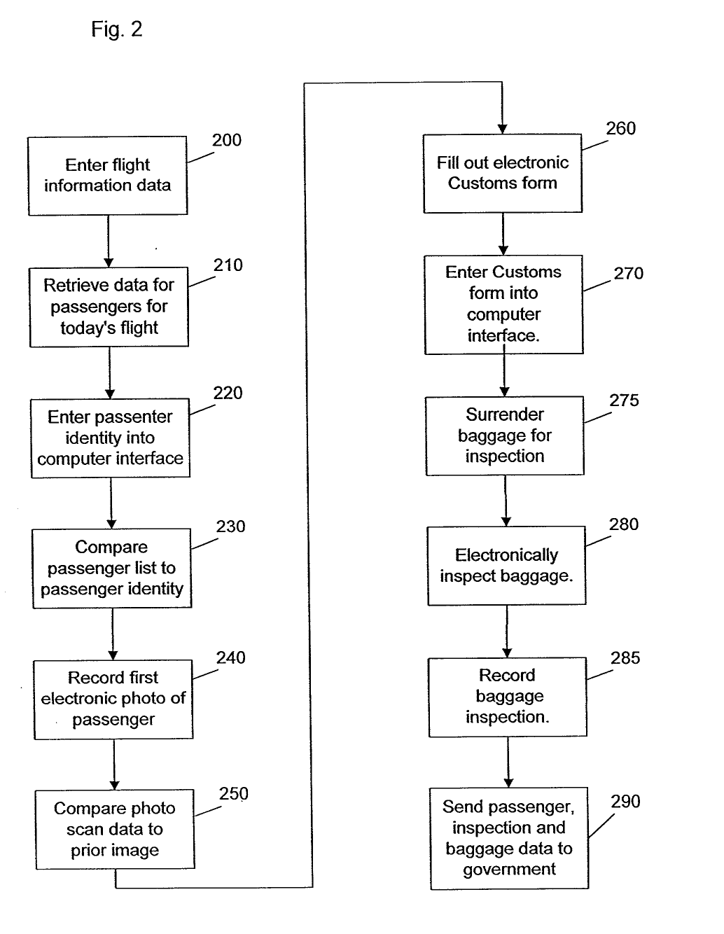

FIG. 2 is a flowchart for a portion of the process that occurs in the country from which passengers are flying, that is, the out-bound country. An airline that flies scheduled routes will desirably have flight data for the present day's flight entered 100 and segregated into a memory of a computer or computer interface at a check-in counter. The computer interface is linked to a computer network, either local or global, of the airline. The airline will also retrieve data on passengers with reservations for a particular flight 210. A passenger approaches the airline check-in counter and enters information 220 concerning his or her identity into a computer interface at the check-in counter. The passenger may be required to know a password or personal identification number (PIN) to access the computer. The information entered may be indicative of the passenger's identity, e.g., a passport number, driver's license number, or a bar code indicative of the passenger's identity. In some embodiments, a passport may not be required for travel between nations. Treaties or other agreements between nations may require other information that is sufficient to identify the passenger, such as a driver's license or other personal identification. The information scanned or entered into the computer interface may include an image from the passport or other personal identification.

The computer interface at the check-in counter will check information on the particular passenger and compare the information with the data on passengers with reservations for the particular flight 230. In one embodiment, a security interview may also be conducted manually by airline personnel or automatically by the passenger responding to questions from the computer or computer interface. If the data match, and the passenger has a reservation, a first electronic photo of the passenger may be recorded 240 into a computer-accessible memory. The photo may be compared and matched 250 with the image taken from the passport or driver's license, or other known prior or officially approved image of the passenger. If the data match, the computer may then present the passenger with an electronic customs form, such as a Customs Declaration Form. The passenger then fills out the form 260 and enters the data into the computer interface 270. Instead of using an electronic camera, an actual photographic image of a passenger may be taken and scanned into the computer memory. It is not strictly necessary that a camera, such as a video or still camera be used. Any technique using biometric data that uniquely identifies a person may be used, including but not limited to, a fingerprint, a palm print, an iris scan, or a voiceprint, or a combination thereof. This information may also be saved or forwarded, or both, as required.

The passenger's baggage is removed from the passenger's control 275 by surrendering the baggage for inspection. The passenger's baggage then may be inspected by hand or by electronic techniques 280. The electronic techniques may include x-ray or other visual techniques, and may also include an Explosive Detection System (EDS), or other electronic or chemical inspection techniques. An important point of baggage inspection is that an electronic record, such as an x-ray or EDS scan, may be made and saved 285. The baggage inspection record, along with passenger information and the completed customs forms are forwarded 290 to officials of a government or agents of the government, in the destination country. The officials may then review the information. The officials may inspect, review, and compare the information concerning the passengers, the baggage, and customs declarations. The officials may then decide which passengers should receive personal processing by customs or immigration in the in-bound country. The officials forward this information to the airline for use upon deplaning. In one embodiment, the government may require that the airline receive and relay an instruction to every passenger to proceed through Customs and Immigration, or that the passenger can proceed without further inspection. In other embodiments, the government may require that only passengers selected for customs or immigration (or both) be specifically notified. In another embodiment, the government may require that all passengers not selected receive a pass or clearance to proceed without further processing. All embodiments are meant to be covered by the present invention.

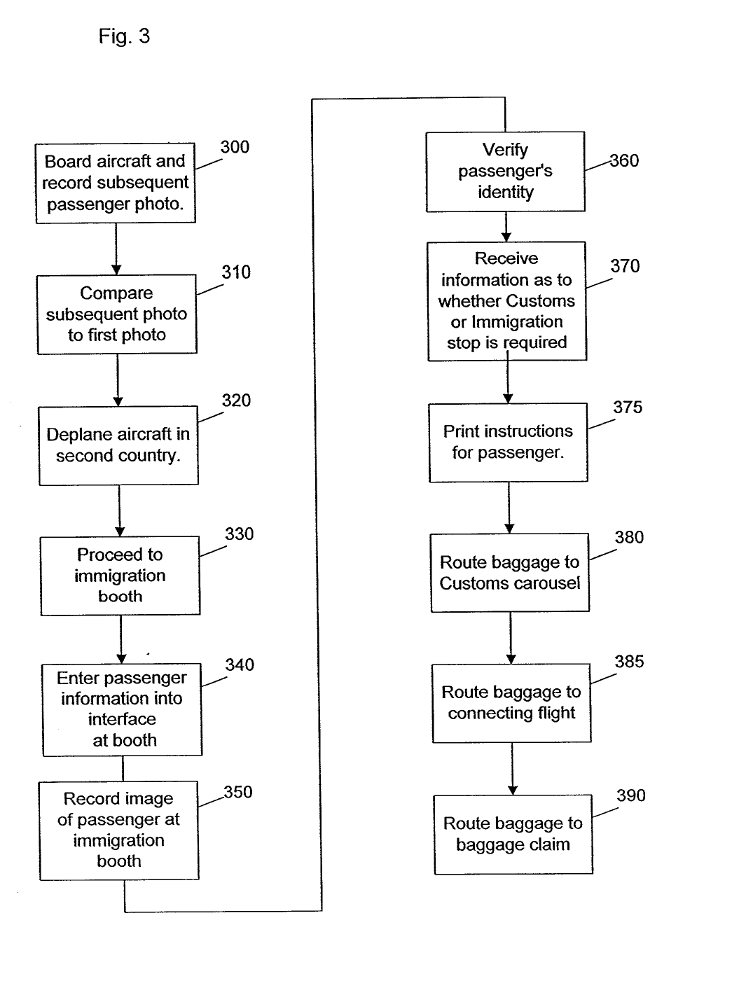

FIG. 3 depicts the process once the passengers begin to enplane. A video or still electronic camera may record one more electronic photo 300 of a passenger and compare this photo to the first electronic photo or to the passport or driver's license photo 310 to ensure that the passengers enplaning are the same passengers that checked in. Upon arrival in the inbound or destination country, the passengers deplane 320 and proceed to an immigration booth 330. In one embodiment, the Immigration booth is similar to the check-in counter in the outbound country. The passengers once again enter into a computer interface at the Immigration booth information indicative of their identity 340, such as a PIN and then a passport number, passport barcode, or driver's license number. A video or still electronic camera may record another photo of the passenger at the Immigration counter 350. The data is sufficient to verify each passenger's identity 360.

The airline has now received from the government in the in-bound country information on which passengers must proceed to customs or immigration or both 370. Upon verifying each passenger's identity, a computer or computer interface at the Immigration outputs instructions to each passenger to proceed to customs or to Immigration or to neither. In one embodiment, a printer prints a ticket for each passenger with the instructions 375. In another embodiment, the instructions to passengers not selected to proceed to customs or to immigration are printed on a green background or with green ink; passengers selected to proceed to Customs or to Immigration are printed on a red background or with red ink.

Baggage from passengers selected is routed automatically from the airline to the customs carousel 380. Baggage from passengers not selected and who have connecting flights is routed to the connecting flight 385; baggage from passengers not selected and who do not have connecting flights is routed to a baggage claim area 390, such as a baggage claim carousel.

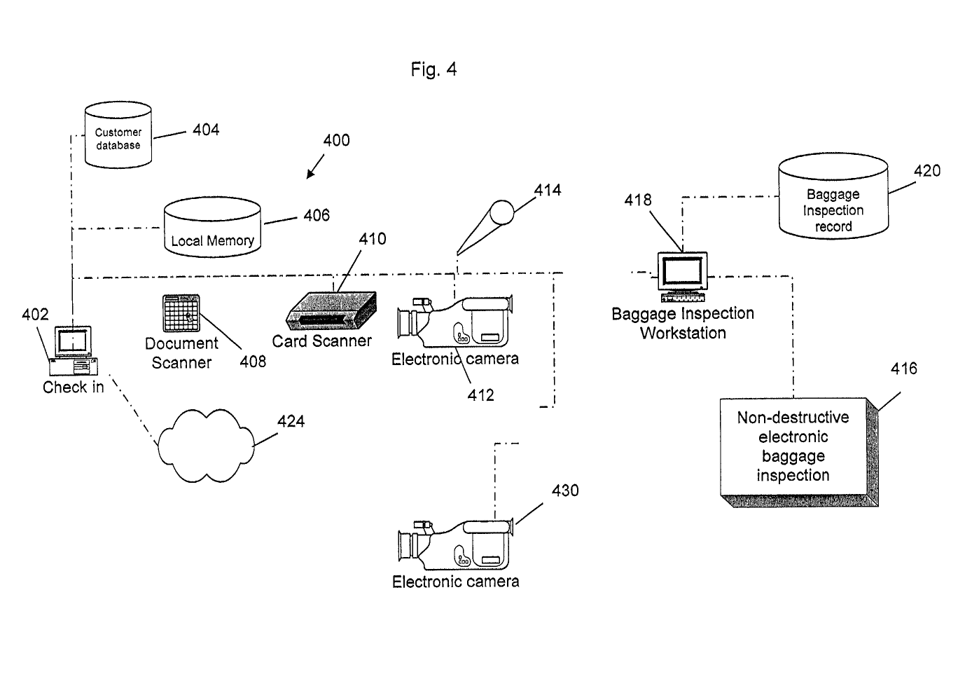

FIG. 4 is a diagram of apparatus useful in processing passengers, baggage, and information concerning passengers and baggage. In the outbound country, preferably at the point of embarkation, an airline check-in counter 400 has a computer or computer interface 402, with access to a first memory 304 containing a database of information on the airline's customers. The database may reside locally or may be at a remote location, such as a main database storage facility for the airline in another country. Interface 402 has at least one memory 406 in addition to the first memory 404. Also linked to computer 402 is at least one scanner 408, 410.

The scanner 408 may be of a type to scan information from a flat document, such as a page of a passport or a driver's license or other identity card. The scanner 410 may also be of the “swipe” variety, suitable for reading a memory on a card or card-like device, or the scanner could be suitable for reading a barcode, such as a standard infrared barcode reader. Any magnetic or electronic device suitable for receiving information concerning the identity of the passenger is meant to be included. A camera 412 may also be available for recording an electronic image of the passenger. A microphone 414 may also be used to enter a voice sample from the passenger. Other biometric data may use other types of entry devices. The electronic image of the passenger may be processed by software residing on a computer accessible to airline personnel and saved after processing; or the image may be simply recorded. Software may be voice-recognition software, facial recognition software, or if fingerprints, palm prints, or iris scans are used, feature recognition software.

The passenger's baggage is also processed at the out-bound country. The processing may be accomplished by airline personnel or by third-party personnel after the passenger has surrendered control of the baggage. A baggage inspection system 416 is used to inspect and save a record of each passenger's baggage. The baggage may utilize x-rays or other penetrating media to render a visual record of the inspection. A user uses a computer or computer interface 418 to control the inspection system 416 and save a record of each passenger's baggage on a computer memory 420. The data should be transferable to another computer and computer memory, such as airline computer 402 and memory 406. The goal of inspecting and saving is to transfer the inspection record to officials of the in-bound country for their review. The computerized information may be transmitted to the government of the destination country via the Internet 424 or by any other convenient method. In addition to visual-type records, other inspections or additional baggage inspections may be made, such as by systems meant for scanning by an Explosive Detection System (EDS) or other electronic or chemical inspection. Records of the inspections are kept and forwarded to officials of the in-bound country.

A passenger who has completed the check in process may proceed to boarding the aircraft. In one embodiment, a camera 430 may record another image of the passenger as he or she enplanes, to ensure that the passenger who checked in is the passenger who boards the aircraft. This image may be compared with passport data, passenger data, or an image previously recorded, and the image may also be stored for later retrieval or referral. The inspection may be accomplished manually by airline personnel or by a computerized process. As mentioned above, it is not strictly necessary that a camera, such as a video or still camera be used. Any technique that uniquely identifies a person may be used, including but not limited to, a fingerprint, a palm print, an iris scan, or a voiceprint. This information may also be saved or forwarded, or both, as required.

Once the passenger has completed check in and boarding, all or some of the information from the passenger identification and the baggage inspection may be forwarded to appropriate government officials in the in-bound country. The use of the information is not limited to customs and immigration officials. It may be desirable, or required, for the airline or for others to whom the information is provided, to share the information with the Federal Inspection Service or an agency that deals with criminal law enforcement. These agencies include, but are not limited to, a national or federal police force, a federal inspection service, a federal aviation administration, an agriculture department, a civil aviation authority, public health administration officials, fish, game and wildlife officials, or other governmental authority with interest in incoming passengers and goods. The government then informs the airline of which passengers and which baggage the government wishes to inspect personally. The airline then makes this information available at its Immigration booth in the in-bound (destination) country. The airline also uses this information to route baggage of the passenger to a customs carousel, to a connecting flight, to a baggage claim area, or to another destination as desired.

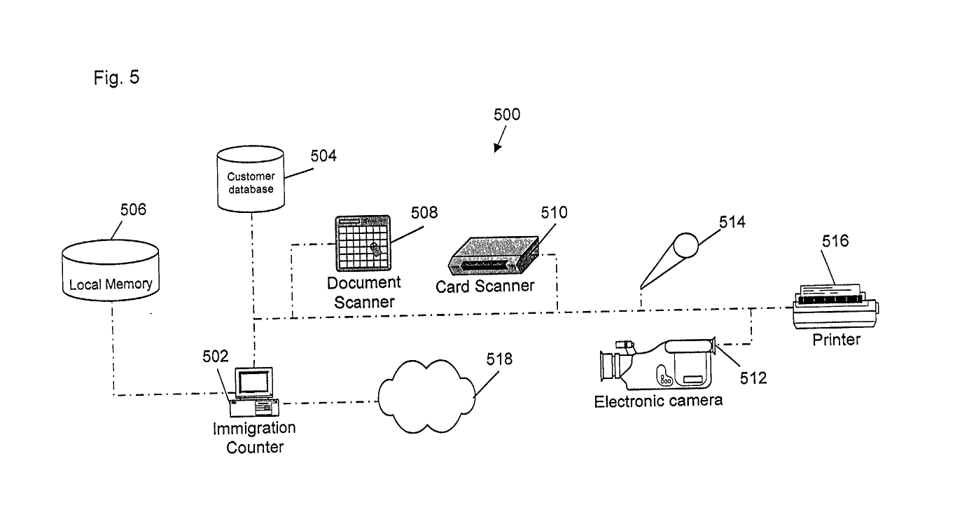

Once the aircraft has completed its trip, the passengers deplane and proceed to an Immigration booth. FIG. 5 depicts an apparatus suitable for processing passengers and baggage at this stage. The Immigration booth 500 has at least one interface 502 having access to at least one database 504 and also having at least one memory 506. The interface 502 may also be linked to at least one scanner 508, 510 for entering information from each passenger. The scanner may be used to scan in information to uniquely identify each passenger, such as a page from a passport, a passport number, or a barcode used to identify the passenger. The Immigration booth may also be equipped with a camera 512, preferably an electronic video or still camera. Instead of using an electronic camera, an actual photographic image of a passenger may be taken and scanned into the computer memory. A microphone 514 or other biometric data entry device may be used to record a voice sample or other biometric data of the passenger.

The airline may then use these images and databases to verify the identity of each passenger. During the flight, the government of the in-bound country has reviewed the information forwarded by the airline. The government then forwards instructions to the airlines on which passengers and baggage must process through customs or immigration. The government may forward these instructions to the airline via the Internet 518 or other communications media. The passenger may receive routing instructions 516, such as a ticket or card that may be printed at the interface, instructing the passenger to proceed to customs or to immigration, or that the passenger is free to proceed as he or she wishes. In one embodiment, the ticket or card may be printed on green paper or with green ink if the passenger is free to proceed, while the ticket or card may be printed on red paper or with red ink if the passenger should proceed to customs or to immigration.

In another embodiment, an international passenger is processed from a first country to a second country by dividing the processing into three flows. Information concerning the passenger and the baggage is one flow, the passenger is processed in a second flow, and the baggage of the passenger is processed in a third flow.

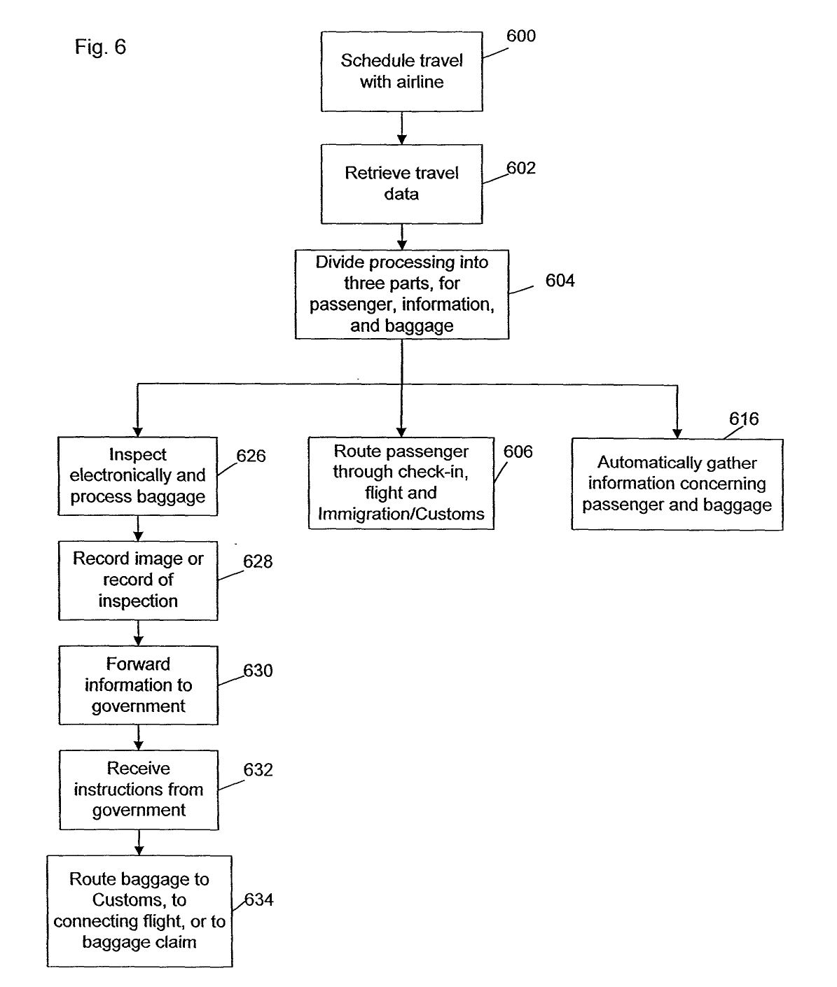

One method of processing an international traveler splits the process into three parts. In FIG. 6, a passenger schedules international travel 600 with an airline or transport agent. Information concerning the passenger and the flight date are entered into a computer interface and may be transferred 602 to a different computer or a different memory location as the travel date nears. The processing is then split into three parts 604, for the passenger 606, the baggage of the passenger 616, and information 626 concerning the passenger and baggage.

FIG. 6 depicts the routing for the baggage of the passenger. The baggage of the passenger is inspected 626 by an electronic method, such as a visual x-ray image, and at least one record is made of the inspection. The baggage may also be inspected by other methods, such as an Explosive Detection System (EDS), and a record made of that inspection. An image or record of the inspection or inspections is saved 628 and may be sent to the government or agent of the government of the destination country 630, where images or records are reviewed or inspected. The airline or travel medium then receives instructions 632 from the government as to whether or not the government has an interest in the passenger or the baggage. The baggage is then routed 634 to either a customs carousel, or to a connecting flight for the passenger, or to a baggage claim area.

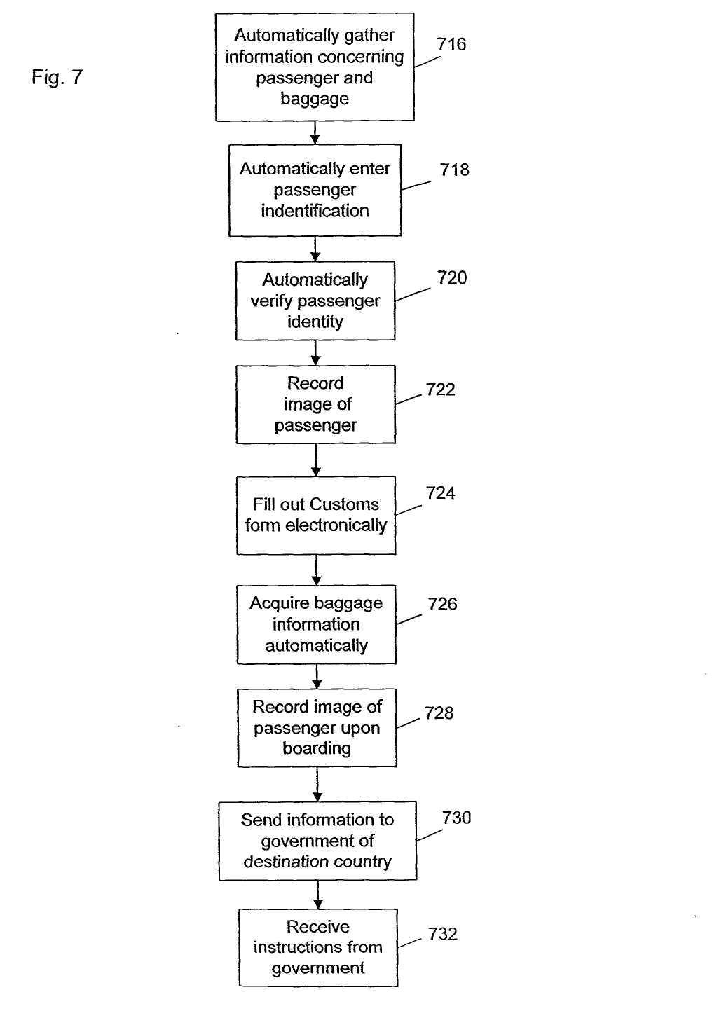

FIG. 7 depicts a process for automatically gathering information concerning the passenger and his or her baggage 716. Data concerning the identity of the passenger is gathered automatically 718, such as by retrieving personal information from a computer record, or by entering information via scanning a passport, an identity card, or a computer with stored information concerning the identity of the passenger. A first image of the passenger may also be scanned 720 from an electronic video or still camera, the first image used for comparison with a passport photo or known prior image stored in a computer, to verify the identity of the passenger. The first image may be stored in a computer memory 722. As noted above, biometric data other than a photo may be used.

Other information is also gathered automatically, when the passenger enters information into an electronic customs form 724 on a computer interface and stores the information on a computer or computer memory. Information from a baggage inspection record is also gathered automatically 726, and stored in a computer. When the passenger boards an aircraft or other international mass travel medium, such as a ship or a bus, his or her identity may be verified by another electronic image 728 recorded by another electronic camera. This image may be stored on a computer. The information gathered automatically concerning the passenger is sent to a government 730 or governmental agent in the destination country. This information may include the passenger's identity, the customs declaration, the passenger's electronic image, an inspection image or result from a baggage inspection, and any other information required by the government of the destination country. The government then sends instructions 732 to the airline or travel company concerning any passengers in whom the government has an interest or passengers the government wishes to proceed to customs or immigration.

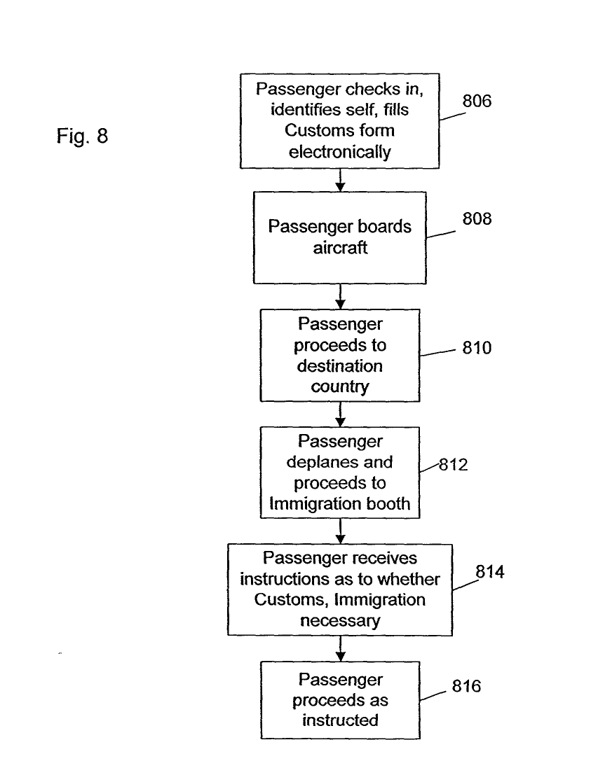

While the information is being processed, the international passenger is also being processed according to the flowchart depicted in FIG. 8. The passenger checks in with the airline with which he or she has scheduled travel 806. After providing information concerning his identity, his image, and the customs form, the passenger may board the aircraft 808 or mass travel medium and proceed to the destination country 810. The passenger deplanes the aircraft or travel medium 812 and proceeds to an Immigration booth 814. At the Immigration booth, the airline or transport company provides the passenger with instructions, according to whether the government of the destination country has an interest in the passenger, or the baggage, or neither. The passenger then proceeds to customs, to immigration, or to a destination of his or her own choice 816. The process may also be used without all the desirably automated features discussed above, such as embodiments using some of the automated features, in conjunction with equipment currently available and in use at many airports.

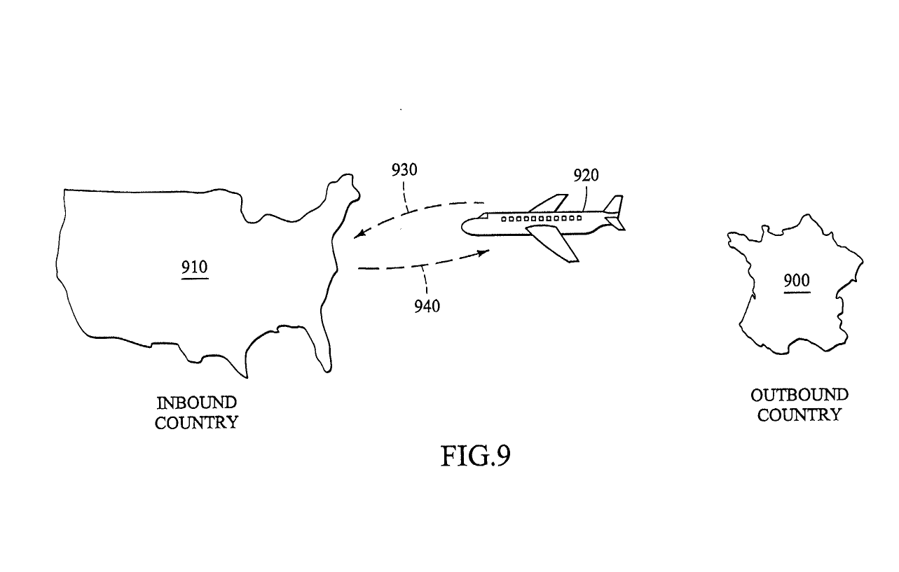

FIG. 9 discloses another way to practice the invention. Rather than filling out a customs form manually, or at a computer interface at the check in counter, the aircraft may have a computer interface to customs officials in the in-bound country. In one embodiment, for travel from an out-bound country 900 to an inbound country 910, passengers on an aircraft 920 may fill out customs forms at an on-board computer interface. The data may then be transmitted 930 to officials in the in-bound country. After review, the officials may then notify 940 passengers on the aircraft as to who should proceed to customs upon landing.

While this invention has been shown and described in connection with the preferred embodiments, it is apparent that certain changes and modifications, in addition to those mentioned above, may be made from the basic features of this invention. For example, passports are normally required for passengers traveling from one country to another. However, the growth of international travel and the proximity of some countries may lead to treaties in which passports are not required for nationals of reciprocating countries. In these instances, other identification may suffice. The alternate identification may be a driver's license or personal identification card issued by a nation or a political subdivision of the nation, such as a state of the United States or a province of Canada. The invention is meant to include the use of any identification technique acceptable to the in-bound country. Thus, a scan of a unique identifier of a person may be used in lieu of an image scan or a photograph. These unique identifiers include, but are not limited to, a fingerprint, a palm print, an iris scan, and a voiceprint.

The discussion above has mentioned x-ray and EDS inspection of baggage. The invention is not limited to such devices or techniques, and is meant to include any inspection technique that may be accomplished automatically and may produce an electronic record. Thus, any penetrating radiation, such as x-rays, may be used. Magnetic devices, or electromagnetic devices, such as magnetic resonance imaging (MRI) devices may be used. It is conceivable that other non-destructive inspection techniques may be used, such as ultrasonic techniques (contact or non-contact), eddy-current devices, or other electromagnetic techniques. The invention is meant to encompass all of these and other techniques. Virtually any technique may be used so long as it produces a recordable and electronic record that the airline or inspection personnel may review and send to the government of the destination country.

There are many ways to practice this invention. As an example, the discussion above has focused on aircraft travel, because of its popularity and convenience for long distance travel. The method may be used for shorter travel excursions between countries, such as when a bus is used for travel. The method may also be used for ocean travel on ships accommodating a large number of passengers, in which the ocean liner and the passengers will benefit from speedy processing of large numbers of travelers. Accordingly, it is the intention of the applicants to protect all variations and modifications within the valid scope of the present invention. It is intended that the invention be defined by the following claims, including all equivalents.

What is claimed is:

1. A method for processing an international passenger, the method comprising:
entering information identifying the passenger a first time into a computer interface;
recording a first electronic image of the passenger;
comparing a prior image of the passenger to the first image;
sending data identifying the passenger to a government or governmental agent in a destination country;
entering information identifying the passenger a second time into a compute interface;
recording a second electronic image of the passenger;
comparing the second image to a prior image of the passenger; and
routing the passenger in accordance with the data and an instruction from the government or governmental agent.

2. The method of claim 1, wherein the first electronic image is recorded in an originating country.

3. The method of claim 1, wherein the second electronic image is recorded in a destination country.

4. The method of claim 1, wherein the second electronic image is recorded on an aircraft.

5. The method of claim 1, wherein the electronic image is selected from the group consisting of a photograph, a fingerprint, a palm print, an iris scan, and a voiceprint.

6. The method of claim 1, further comprising entering data indicative of flight information for the passenger into the computer interface.

7. The method of claim 1, further comprising retrieving data of passengers scheduled for a flight from a first computer memory and storing the data in a second computer memory.

8. The method of claim 1, wherein comparing the prior image to the first image is performed by a computer with software selected from the group consisting of feature recognition software, voice recognition software, and facial recognition software.

9. The method of claim 1, further comprising taking a subsequent image of the passenger and comparing the subsequent image to the first electronic image, and routing the passenger according to a result of a comparison of the first electronic image and the subsequent image.

10. The method of claim 1, further comprising filling out a customs declaration form, entering the form into the computer memory, sending the form to the government or governmental agent, and routing the passenger in accordance with the government or governmental agent.

11. The method of claim 1, further comprising electronically inspecting baggage of the passenger, making a record of the electronic inspecting, entering the record into the computer memory, sending the form to the government or governmental agent, and routing the baggage in accordance with the government or governmental agent.

12. The method of claim 1, further comprising giving the passenger notice of an instruction of the government or government agent.

13. The method of claim 1, wherein no instruction is received from the government or governmental agent, and the passenger is not required to process through customs or immigration.

14. The method of claim 1, wherein no instruction is received from the government or governmental agent, and the passenger is automatically required to process through customs or immigration or both customs and immigration.

15. An apparatus for processing an international passenger from a first nation to a second nation, the apparatus comprising:
a check-in counter having a first computer interface;
a first computer memory linked to the first computer interface;
a second computer memory linked to the first computer interface, wherein a user transfers data concerning the international passenger from the first computer memory to the second computer memory;
first means for entering information concerning the international passenger into at least one computer memory;
a customs form stored in at least one computer memory; and
a baggage inspection system, wherein the check-in counter, second computer memory, first means for entering information, and baggage inspection system are located in a first nation, and wherein information from a passport of the passenger is entered into the second computer memory, the passenger fills out a customs form and stores said form into a computer memory, and a record from a baggage inspection of the baggage of the international passenger is stored in at least one computer memory;
an immigration counter having a second computer interface;
second means for entering information concerning the international passenger into at least one computer memory, said second means linked to the second computer interface; and
means for outputting an instruction for the passenger, wherein the immigration counter, second means for entering information and means for outputting an instruction are located in a second nation, and wherein information from a passport of the passenger is entered into a memory of the second computer interface and an instruction for the passenger is printed at the immigration counter.

16. The apparatus of claim 15, wherein the first and second means for entering information are a first camera and a second camera for taking an electronic image of the international passenger, said first camera linked to the first computer interface of the check-in counter and said second camera linked to the second computer interface of the immigration counter.

17. The apparatus of claim 15, wherein the first means and second means for entering information are selected from the group consisting of a computer interface, a document scanner, a card scanner, a microphone, and a barcode scanner.

18. The apparatus of claim 15, further comprising a remote camera for recording an image of the international passenger, said remote camera linked to a computer in the first nation.

19. The apparatus of claim 15, further comprising software selected from the group consisting of feature recognition software, voice recognition software, and facial recognition software, accessible by at least one computer or computer interface at the check-in counter or immigration counter.

20. The apparatus of claim 15, wherein the means for outputting an instruction is selected from the group consisting of a computer interface with instructions for the passenger and a printer that prints instructions for the passenger.

21. The apparatus of claim 20, wherein the printed instructions are color-coded.

22. The apparatus of claim 15, wherein the first computer memory contains a database of customer information.

23. A method of processing an international traveler from a first country to a second country, the method comprising:
dividing the processing into three parts, wherein the passenger, baggage of the passenger, and information concerning the passenger and baggage of the passenger, are sent from the first country to the second country;
gathering information and sending information concerning the passenger and baggage of the passenger, wherein information concerning the passenger and the baggage of the passenger is automatically gathered and processed, and sent to a government official of the second country;
sending the baggage through an electronic baggage inspection, sending the baggage to the second country, and routing the baggage to a location selected from the group consisting of customs, a baggage claim area, and a connecting flight of the passenger; and
sending the passenger from the first country to the second country, and then sending the passenger to further processing selected from the group consisting of customs, immigration, and no further processing.

24. The method of claim 23, further comprising scheduling travel of a passenger, and transferring data concerning the passenger from a first computer memory to a second computer memory.

25. The method of claim 23, further comprising filling out an electronic customs form and saving the form into a memory of a computer.

26. The method of claim 23, wherein the passenger proceeds to an Immigration booth upon arrival in the second country to automatically verify his or her identification and to receive instructions for proceeding.
